(19) United States
(12) Patent Application Publication
(10) Pub. No.: US 2005/0115341 A1
(43) Pub. Date: Jun. 2, 2005

(54) Method for moving massas and apparatus for its implementation

(76) Inventor: Pauli Partanen, Vantaa (FI)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/496,891

(22) PCT Filed: Nov. 13, 2002
(86) PCT No.: PCT/FI02/00896

(30) Foreign Application Priority Data
Nov. 29, 2001 (FI) 20012333

(51) Int. Cl. F16H 21/16

(52) U.S. Cl. 74/84 S; 74/25

(57) ABSTRACT

A method and apparatus are disclosed for generating a net propulsion force with the help of inertial forces.

The invention relates to a method and apparatus for utilizing forces acting at different magnitudes and in different directions such that the law of equal action between a Newtonian force and its counterforce can be annulled in the method according to the present invention and apparatus implementing the method. As, a result, also the law of conservation of impulse is annulled in the specific situation created by virtue of the present invention.

In the prior art, no method or apparatus has been devised capable of annulling the law of equal action between a Newtonian force and its counterforce.

It is an object of the present invention to provide in an apparatus such a propulsion force that exceeds the counteracting propulsion force created in the apparatus over a given period of time. The resulting difference of the propulsion forces gives a net propulsion force tending to actuate and actually actuating the apparatus to move in the direction of the net propulsion force.

The invention is based on a concept of controlling the rhythmic movement of a mass to occur in rotations about a fixed axis so that the velocity of the mass along its trajectory is changed by pulling the mass toward the axis of rotation and, respectively, releasing the mass farther away from the axis of rotation in a fashion that keeps the instantaneous speed of the mass in a given direction in regard to the. axis of rotation unchanged at all times. According to the laws of physics, this reciprocating movement of the mass first toward the axis of rotation consumes an equal amount of energy as will be released by the mass as it recedes toward its initial trajectory of rotation. This change in the speed of the mass also causes a change in the force exerted by the mass in a direction outward from the axis. Conventionally, this force is called the centrifugal force.

When the trajectory of the mass is divided into equally large sectors as seen from the trajectory center point, the mass exerts as a function of time in the opening direction of the sector a force effect on the apparatus, more specifically a propulsion force that changes as the mass moves from one sector to the next.

Summing the force vectors exerted outward from the center point of the trajectory at different instants of time in the different sectors gives a resultant vector that acts so as to move the apparatus in the acting direction of the resultant force vector.

Next, the invention will be examined in greater detail by making reference to the attached drawing, wherein

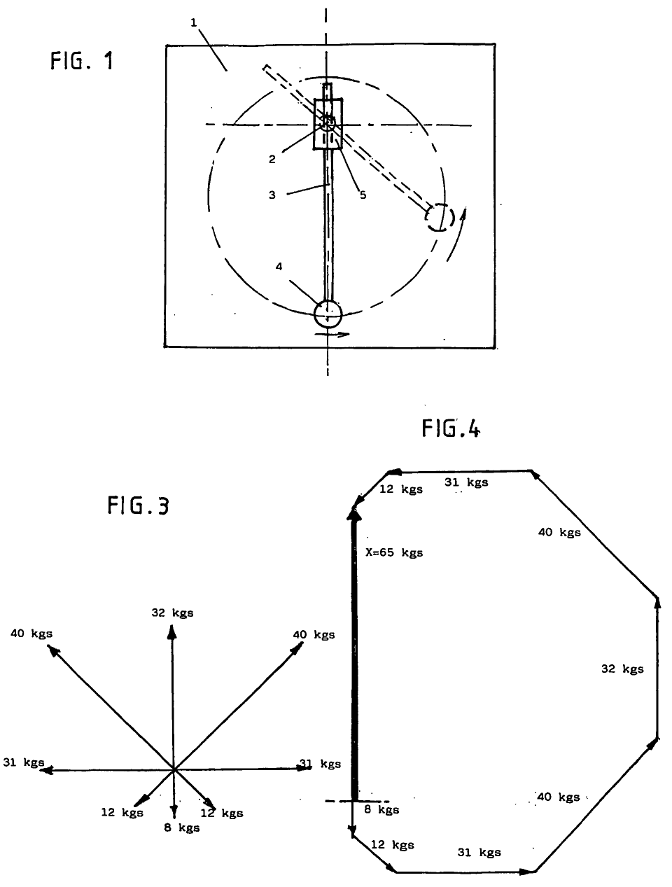

FIG. 1 shows a top plan view of an embodiment of the apparatus according to the invention;

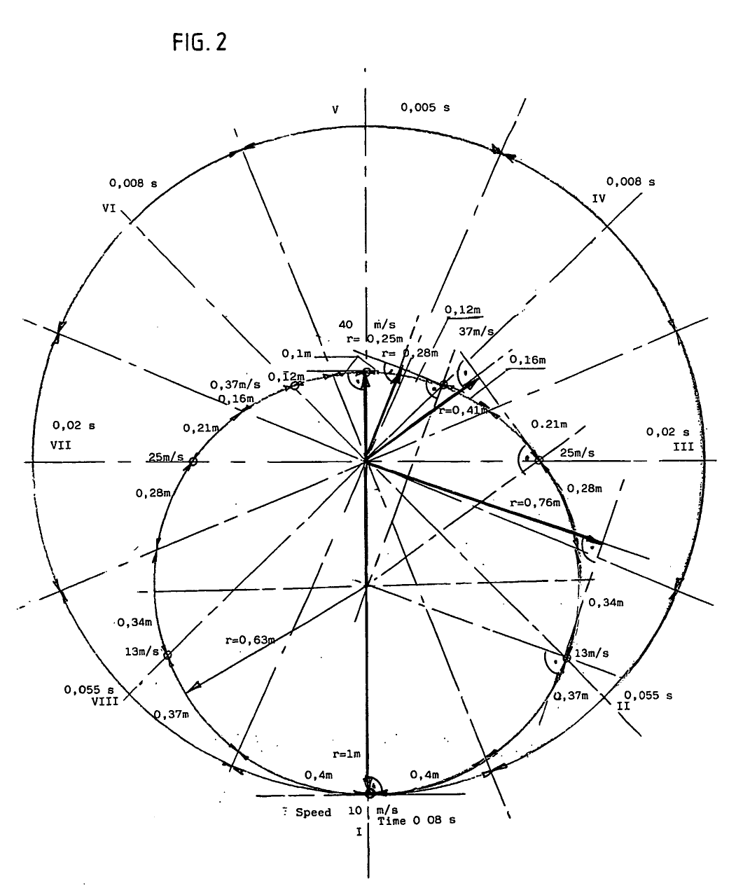

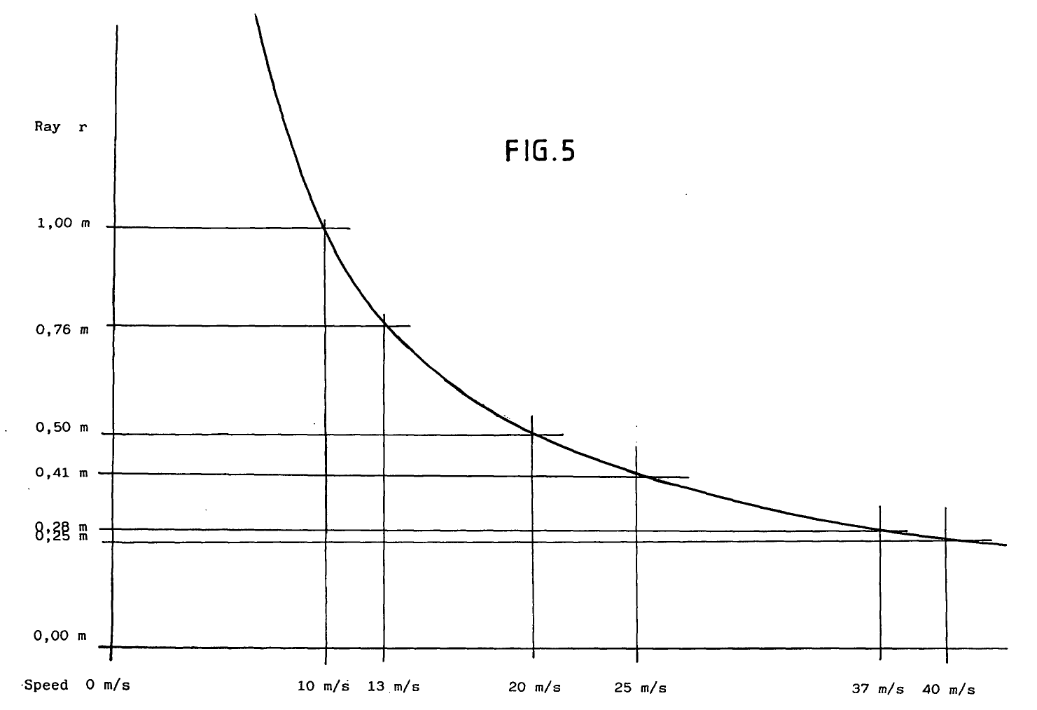

FIG. 2 shows one rotational cycle of the mass about its axis of rotation, the smaller circle of the diagram representing this trajectory, whereby the distance traveled by the mass along. its path is indicated by each sector together with the radius of the sector that is needed to find the approximate speed of the mass from the graph of FIG. 5, the sectors of diagram also having marked therein the average time required from the mass to move the distance represented by the circular segment of the sector;

FIG. 3 shows the force vectors exerted by the mass outward from the axis of rotation in the middle point direction of the equal-angle sectors, whereby the force vectors are computed by multiplying the average magnitude of the centrifugal force by the average time required from the mass to travel the arcuate path of the sector;

FIG. 4 shows the exerted force vectors of FIG. 3 drawn into a polygon in which the direction and magnitude of each one of force vectors are in scale resulting in a sum vector x of the forces exerted over one complete rotation cycle of the mass about its axis of rotation;

FIG. 5 shows a graph suited for estimating at the middle point of the trajectory sector on the basis of the trajectory radius r of the speed of the mass herein that later is considered to be the average speed of the mass as it moves over the circular segment of the trajectory at the sector in question;

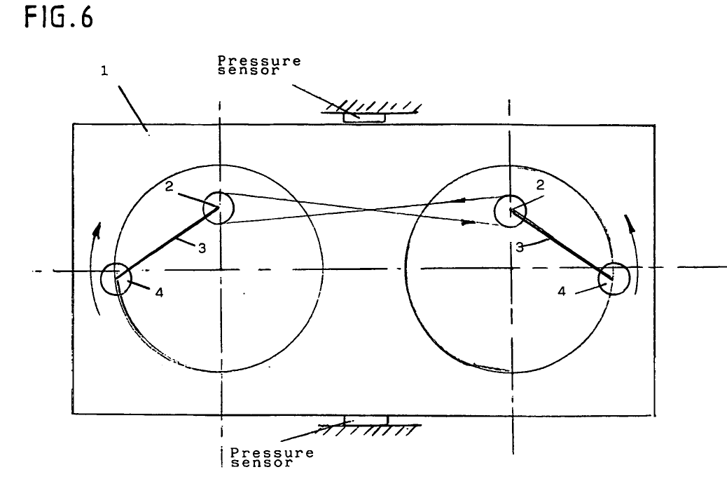

FIG. 6 shows two identical apparatuses connected with each other, whereby the apparatuses are arranged to operate mirroring each other and forced to cooperate with the help of a chain-and-sprocket mechanism, for instance;

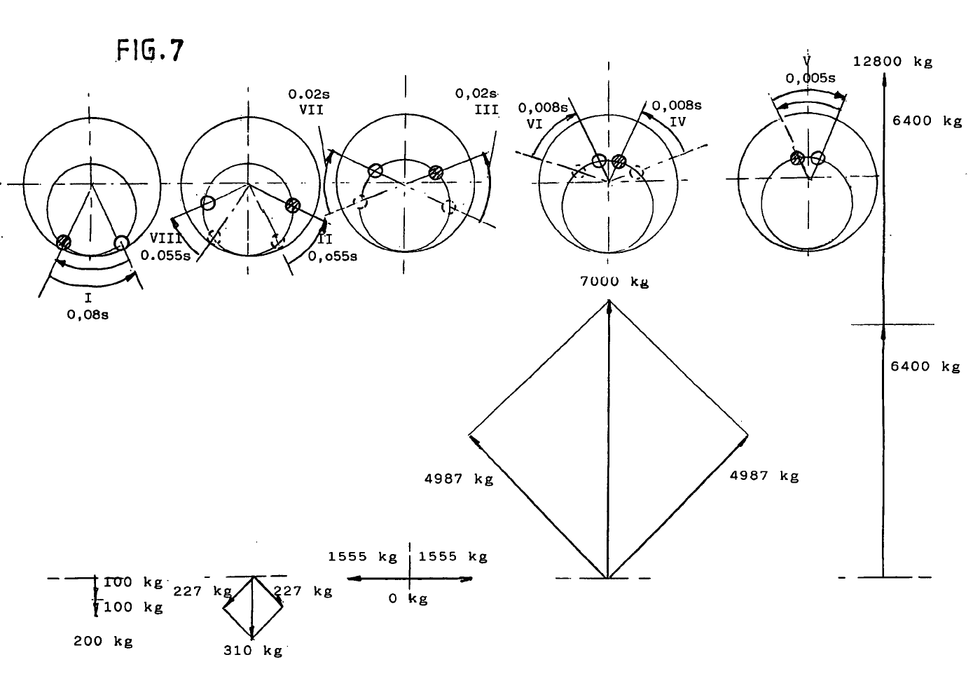

FIG. 7 shows at the middle points of the trajectory sectors the average magnitudes and the sum vectors of the centrifugal forces exerted by the masses of FIG. 6 connected to rotate in a mirrored configuration with each other;

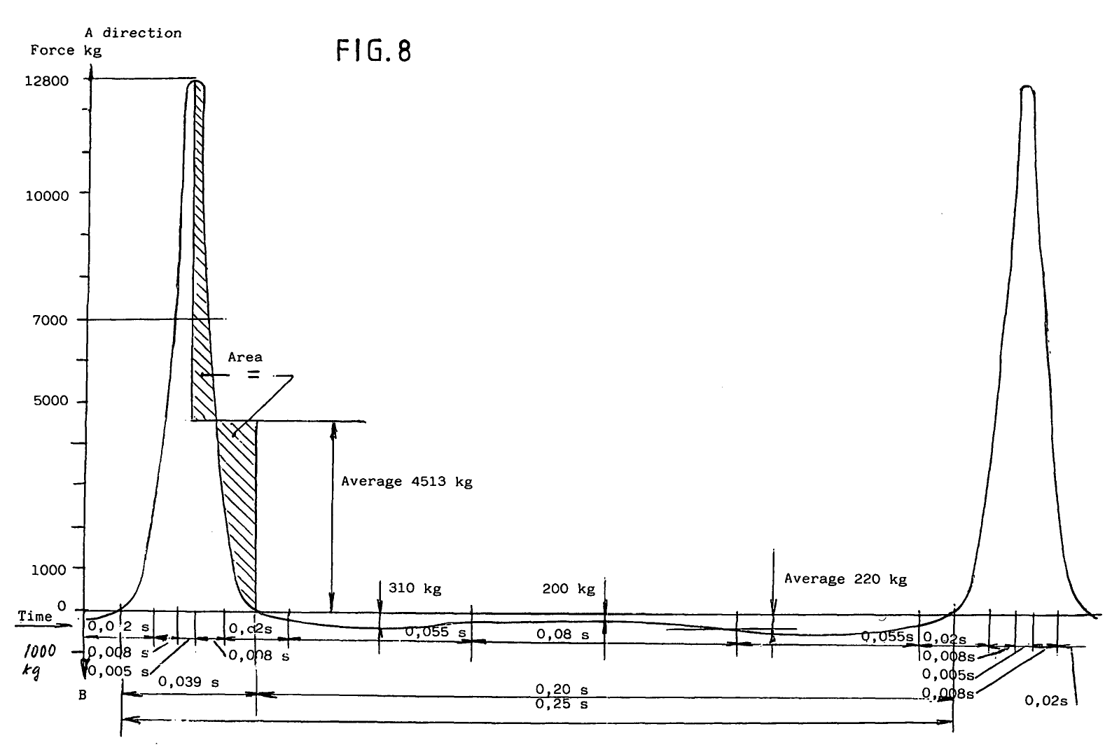

FIG. 8 shows the sum vectors of the centrifugal force vectors obtained from FIG. 7 located on a time axis at the middle point of the sectors, whereby at the sectors on the time axis is marked the average time required from each one of the masses to move over the distance represented by the individual sector; and

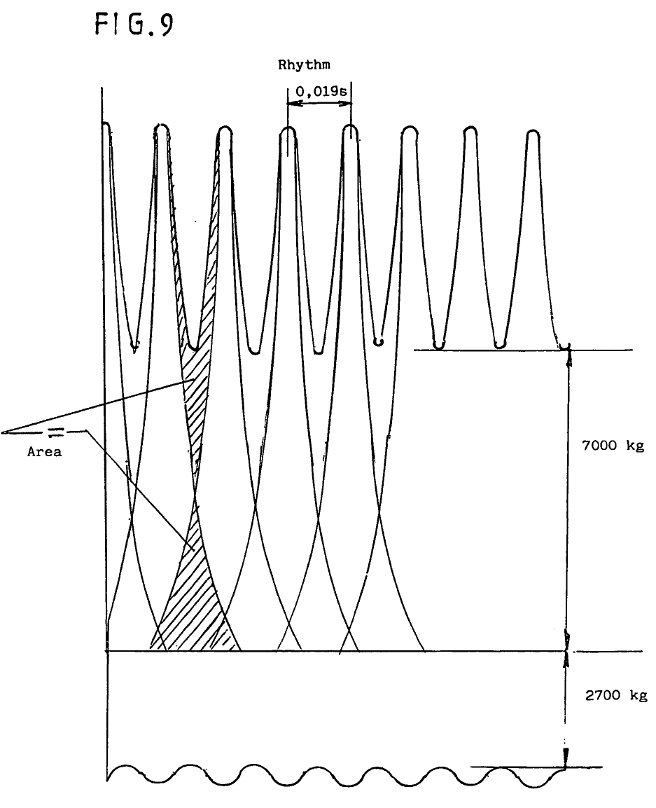

FIG. 9 shows a graph obtained by connecting 13 pcs. apparatuses of FIG. 6 to each other with their long sides adjacent to each other and each one of the apparatuses performing at equal intervals one cycle during the full operating cycle of the apparatus of FIG. 6.

Referring to the diagrams, the embodiment of the invention illustrated therein comprises in a top plan view a horizontally mounted base 1 having a vertical shaft 2 mounted thereon and supporting an arm 3 with a mass 4 attached thereto rotating thereabout. The arm is adapted to move radially reciprocatingly actuated by a drive means 5. When the drive means pulls the arm, kinetic energy is imparted to the mass rotating about the shaft. Respectively, when the mass at the distal end of the arm is allowed to reach a more distant path, the drive means recovers the kinetic energy of the mass. The drive means operates utilizing conventional techniques such as electric and pneumatic technology.

The invention functions as follows. Two identical apparatuses according to the invention are connected adjacent to each other (FIG. 6). The operation of the apparatus assembly can be tested on a horizontally mounted platform in which measurement devices indicate the propulsion forces and durations thereof exerted at different times on the opposite long sides of the system. Inasmuch as the apparatuses are mirrored with respect to each other, their function as a whole can be understood by examining the function of a single apparatus (FIG. 1).

The mass center of mass 4 is actuated into motion about shaft 2 at a radius of 1 m so that the mass speed at the middle point of sector I is 10 m/s. With the help of arm 3, the drive means pulls next the mass toward the shaft so close thereto that the mass at the middle point of sector V travels at a radius of 0.25 m from the shaft. Herein, the maximum speed of the mass is 40 m/s.

This speed increase is caused by the known law of energy conservation stating that when a mass performs rotational movement along a circular trajectory, wherefrom the mass is transferred by external energy onto a new trajectory having a radius half the initial radius, the speed of the mass is doubled and, respectively, if the mass is again transferred herefrom onto a new rotational trajectory again halving the radius, the speed of the mass is increased fourfold compared with the very initial tangential speed of rotation.

In FIG. 2 is shown the circular trajectory of the mass running at a radius of 0.63 m as drawn in the diagram and covering equal sectors I, II, III, IV, V, VI, VII and VIII.

At the middle point of sectors II, III, IV, V, VI, VII and VIII, the mass speed is equal to the speed at which the mass if freed would start a linear motion and meet at 90° angle a radius drawn from the shaft center. Herefrom the mass would start circular motion. The radius of the motion is measured from FIG. 2. Now knowing the length of the radius, the instantaneous speed of the mass at the middle point of the sector is obtained from the graph shown in FIG. 5. This speed is taken as the average speed when the mass travels over the circular arc of one sector.

The length of radius r is next used in computations in which a sufficiently accurate estimate is obtained for the magnitude of the force acting from the center of the shaft toward the center point of the sector by using the conventional equation of centrifugal force written as C=mv²/r, where mass m in the particular case of gravitational falling motion is m=G/g, where G is the measured weight of the object and g is the acceleration of gravity, approx. 9.81 m/s². If the measured weight of mass m is 10 kg, the equation gives m=10 kg/9.81 m/s²=1.02 kg/m/s².

The approximate magnitude of centrifugal force per sector over a trajectory distance equal to the circular arc length of the sector is:

$$\text{Sector I:}$$

$$C = \frac{1.02 {\text{kg/m/s}}^{2} \times {( 10 \text{m/s} )}^{2}}{1 m} = 100 kg$$

$$\text{Sector II:}$$

$$C = \frac{1.02 {\text{kg/m/s}}^{2} \times {( 13 \text{m/s} )}^{2}}{0.76 m} = 227 kg$$

$$\text{Sector III:}$$

$$C = \frac{1.02 {\text{kg/m/s}}^{2} \times {( 25 \text{m/s} )}^{2}}{0.41 m} = 1555 kg$$

$$\text{Sector IV:}$$

$$C = \frac{1.02 {\text{kg/m/s}}^{2} \times {( 37 \text{m/s} )}^{2}}{0.28 m} = 4987 kg$$

$$\text{Sector V:}$$

$$C = \frac{1.02 {\text{kg/m/s}}^{2} \times {( 40 \text{m/s} )}^{2}}{0.25 m} = 6400 kg$$

Sector VI: C=Sector IV=4987 kg
Sector VII: C=Sector III=1555 kg
Sector VIII: C=Sector II=227 kg

When mass 4 moves over a trajectory distance equal to the circular arc length of the sector, the time required from the mass to perform the travel is the travel distance divided by the average travel speed that may be selected to be mass speed at the middle point of the given sector. This speed is obtained from the graph of FIG. 5.

The arcuate sector lengths are measured from an enlarged diagram of FIG. 2.

The average travel time of the mass over the arcuate path length of each sector is:

| | | |
|---|---|---|
| Sector I: | 0.80 m/10 m/s = | 0.080 s |
| Sector II: | 0.71 m/13 m/s = | 0.055 s |
| Sector III: | 0.49 m/25 m/s = | 0.020 s |
| Sector IV: | 0.28 m/37 m/s = | 0.008 s |
| Sector V: | 0.20 m/40 m/s = | 0.005 s |
| Sector VI: = | Sector IV = | 0.008 s |
| Sector VII: = | Sector III = | 0.020 s |
| Sector VIII: = | Sector II = | 0.055 s |

The time required by the mass per one full rotation is 0.251 s.

Knowing the average value of centrifugal force imposed on the mass with the direction of the force in each sector, the effect of the force in the direction of the sector middle point can be computed from equation V=Ct, where V is the average effect of the force (kgs), C is the average value of the centrifugal force (kg) and t is the time the mass needs to travels over the arcuate path of the sector.

Imposed on the center point of shaft 2 toward the middle point of each sector, the force effects per sector are:
V=Ct

| | | |
|---|---|---|
| Sector I: | 100 kg × 0.080 s = | 8 kgs |
| Sector II: | 227 kg × 0.055 s = | 12 kgs |
| Sector III: | 1555 kg × 0.020 s = | 31 kgs |
| Sector IV: | 4987 kg × 0.008 s = | 40 kgs |
| Sector V: | 6400 kg × 0.005 s = | 32 kgs |
| Sector VI: = | IV = | 40 kgs |
| Sector VII: = | III = | 31 kgs |
| Sector VIII: = | II = | 12 kgs |

Now expressing the forces as vectors and drawing the same as vectors of correct direction and length starting from the center point of shaft 2, FIG. 3 is obtained.

When the same vectors are redrawn in correct length and direction into a polygon shown in FIG. 4, a sum vector diagram of the individual force vectors is obtained wherein the difference between the starting point and end point of the polygon represents the force effect that tends to move the apparatus connected to an external mass into the direction indicated by the sum vector. As can be seen from the diagram depicting one full cycle of 0.25 s duration, the resultant force effect is 65 kgs. Hence, this kind of continuously operating apparatus is capable of producing during one second a propulsion force of 65 kgs/0.25 s=260 kg.

To accomplish an apparatus that during its continuous operation is capable of producing propulsion force only in opposite directions, an assembly must be constructed comprising two identical apparatuses connected adjacent to each other and having their masses rotated in opposite directions. This kind of assembly is shown in FIG. 6 that produces a resultant propulsion force in the magnitude of centrifugal force vectors directed in the direction of the sector middle points with their sum vectors as depicted in FIG. 7.

When also the travel time required by the mass to travel over the arcuate path of each sector is taken into account, the graph of FIG. 8 is obtained showing the force effect of the masses during one full cycle lasting 0.25 s. As can be seen from the diagram, for a time of 0.039 s in direction A is exerted a propulsion force varying from zero to 12,800 kg. The average value of the propulsion force is obtained graphically by moving the area of the top portion of the curve as an extension of the lower portion of the graph, whereby the graph gives a propulsion force of 4513 kg during 0.039 s, corresponding to an impulse of 4513 kg×0.039 s=176 kgs in direction A. Hence, the average propulsion force of a continuously operating assembly in direction A is 176 kgs/0.25 s=704 kg.

Respectively in direction B the average value of the propulsion force is 220 kg (as measured from enlarged diagram of FIG. 8) over a time period of 0.2 s. Hence, the impulse is 220 kg×0.2 s=44 kgs, whereby the average propulsion force exerted by a continuously operating assembly in direction B is 44 kgs/0.25 s =176 kg.

Accordingly, the continuously operating apparatus assembly of FIG. 6 can exert in direction A a propulsion force of 704 kg−176 kg=528 kg.

It can be seen that the apparatus of FIG. 1, which represents an exemplary embodiment in the computations, produces in continuous operation a propulsion force of 260 kg. Having two such apparatuses arranged to operate adjacent to each other in an assembly mirroring each other so as to produce propulsion force in direction A, the average propulsion force is estimated at 520 kg that also represents an estimate for the propulsion force produced by the apparatus of FIG. 6.

When an apparatus assembly having 13 pcs. the apparatuses of FIG. 6 connected adjacent to each other with their long sides abutting is constructed, the propulsion force of the assembly in direction A will be 13×528 kg=6864 kg.

Respectively, the graph of FIG. 9 is obtained from which it can be seen that the net value of the averaged, smooth propulsion force is 7000 kg−2700 kg=4300 kg.

In the exemplary embodiment (FIG. 1), the drive means is adapted to rotate about an axis. Alternatively, the drive means can be adapted to pull the mass toward the direction of shaft 2 with the help of, e.g., cables as shown in the assembly of two apparatuses shown in FIG. 6.

The exemplary computations of this text have been carried out using the traditional equation of centrifugal force C=mv²/r, in which the unit of force is kg. This unit of force can be converted into the standardized unit of force known as Newton by way of multiplying the values of centrifugal force by 9.81 m/s², that is, the standardized value of acceleration of gravity. Hence, the propulsion force of the continuously operating apparatus examined in the exemplary computation delivers a propulsion force of 260 kg×9.81 m/s²=2550 N.

To help understand the functionality of the invention, the apparatus discussed herein has been assumed to operate without friction and the drive means having an operating efficiency of 100%, whereby the energy imparted by the drive means to the mass is equal to the energy recovered by the drive means from the mass. The computations have been formulated so as to make it easier to understand the functionality of the invention. Obviously, the invention may be implemented using values and mass trajectories different from those of a circular path. For instance, the mass could travel along an ellipsoidal path.

The functionality of the invention has been proved using uncomplicated and easy-to-understand mathematical means giving only estimates of values that substantiate the scope and spirit of the invention. However, the proof of functionality needs only computationally obtained estimates of the force effect vectors in opposed sectors I and V of the mass path.

In the simplified embodiment of the invention discussed above, the computations have been carried out by dividing in the computations the path of the mass into 45° sectors. Obviously, computations may as well be performed by dividing the path of the mass into smaller sectors of mutually equal angles, whereby also the number of sectors increases respectively. Hereby not only the estimates of force effects given by the computations become more accurate, but also the apparatus appears to deliver a greater propulsion force than that obtained from the exemplary computations.

The computations may also be performed in alternative ways, whereby they must be accomplished with the help of more complex mathematical means that give a more accurate end result.

To a person versed in mechanical physics with capabilities in practical mechanics, it is obvious that the method and apparatus according to the invention can produce propulsion force without ejecting any mass in a direction opposite to that of the apparatus movement, whereby this kind of continuously operating apparatus needs mechanical energy only so much as is consumed via frictional losses into thermal energy, thus offering the invention a variety of different applications in which the invention can replace prior-art arrangements. One of such prior-art systems is the conventionally used machine known as a jet engine that generates a propulsion force from a fuel, whereby the consumed fuel is ejected in one direction as a mass driven by thermal energy.

1-7. (canceled)

8. A method for providing a propulsion force, in which a mass is moved around a center point and additionally in a longitudinal direction of the distance between said mass and said center point, wherein:
the movement of said mass is forced to take place rhythmically along a trajectory;
the speed of the mass around the center point is largest when the distance between the mass and the center point is smallest; and
the speed of the mass around the center point is smallest when the distance between the mass and the center point is largest.

9. A method according to claim 8, wherein two equal masses are moved into opposite directions around a center point and additionally in the longitudinal direction of the distance between each mass and center point, so that the movements of the masses are mirror images of each other with respect to a line in the direction of which from a center point are the point at which a mass moving around said center along its trajectory is closest to the center point and the point at which a mass moving around said center point along its trajectory is farthest from the center point.

10. A method according to claim 8, wherein several masses are moved around a center point and additionally in the longitudinal direction of the distance between each mass and center point, and wherein concerning the trajectory of each mass a line in the direction of which are the points closest to and farthest from the center point is similarly directed, and the movements of said masses are synthronized.

11. A method according to claim 9, wherein several masses are moved around a center point and additionally in the longitudinal direction of the distance between each mass and center point, and wherein concerning the trajectory of each mass a line in the direction of which are the points closest to and farthest from the center point is similarly directed, and the movements of said masses are synchronized.

12. An apparatus for providing a propulsion force, comprising:
a shaft;
a mass;
between the shaft and the mass a connecting arm, arranged to enable rotating said mass, supported by said arm, around said shaft;
drive means for causing the movement of said mass in the direction of said arm; and
means for rotating said mass around said shaft; wherein said drive means and said means for rotating are adapted to move said mass rhythmically along a trajectory, on which the speed of the mass around the center point is largest when the distance between the mass and the center point is smallest, and the speed of the mass around the center point is smallest when the distance between the mass and the center point is largest.

13. An apparatus according to claim 12, wherein said arm is a rigid bar.

14. An apparatus according to claim 12, wherein said arm is a cable.

15. An apparatus according to claim 12, comprising two equal masses and means for rotating them in opposite directions along trajectories, which are mirror images of each other with respect to a line in the direction of which from a center point are the point at which a mass moving around said center point along its trajectory is closest to the center point and the point at which a mass moving around said center point along its trajectory is farthest from the center point.

16. An apparatus according to claim 12, comprising several masses as well as means for moving said masses around a center point and in the longitudinal direction of the distance between each mass and center point.
